(19) United States
(12) Patent Application Publication
(10) Pub. No.: US 2024/0019820 A1
(43) Pub. Date: Jan. 18, 2024

(54) A DATA PROCESSING METHOD AND DEVICE

(71) Applicant: Qicheng Liu, Dongguan (CN)

(72) Inventor: Qicheng Liu, Dongguan (CN)

(21) Appl. No.: 18/034,277

(22) PCT Filed: Dec. 30, 2021
(86) PCT No.: PCT/CN2021/142878

§ 371 Date: Apr. 27, 2023

(30) Foreign Application Priority Data
Jun. 1, 2021 (CN) 202110610280.8

(51) Int. Cl. G05B 15/02

(52) U.S. Cl. CPC G05B 15/02

(57) ABSTRACT

The present invention discloses a data processing method and device, the method including: acquiring apparatus data sent by a hardware driving module, and converting the apparatus data into data in a standard format; dividing, after parsing the apparatus data that is converted into the standard format, the apparatus data into touch event data and control protocol data; encapsulating, according to a preset first data encapsulation format, the touch event data into a touch event; dispatching, according to an event dispatching mechanism of an operating system, the touch event to corresponding application software; parsing the control protocol data, and sending the parsed control protocol data to corresponding application software. The present invention can effectively meet the requirements of an application layer for the acquisition and control of hardware underlying data, and can improve the efficiency of data transmission.

### FIELD

The present invention relates to the technical field of data processing, and in particular, to a data processing method, device and system.

### BACKGROUND

In the prior art, the Android system is configured with a specific system input structure through which all third-party application software acquire hardware input data. In the processing flow of this system input structure, the underlying data needs to be processed by a complex system, and then assigned by the system to the Activity module of the corresponding application layer and then sent to the specific sub-View.

However, in the process of implementing the present invention, the inventors found that the prior art has at least the following problems: the data processing flow of the system input structure is time-consuming and complicated, and the application layer can only passively receive data encapsulated according to a certain standard. For writing software and software that performs gesture processing and some special touch recognition, the data encapsulated according to standards formulated by the system cannot carry complex information at all. And the upper application can only passively receive data output by the input structure in one direction, but cannot perform a corresponding control function through the input structure. If the control function is to be implemented, the upper application must add a control module by itself. Therefore, the result of the system input cannot well meet the requirements of the application layer for the acquisition and control of the hardware input data.

### SUMMARY

An object of embodiments of the present invention is to provide a data processing method, device and system, which can effectively meet the requirements of an application layer for the acquisition and control of apparatus data, and can improve the efficiency of data transmission.

An embodiment of the present application provides a data processing method, comprising:

acquiring apparatus data sent by a hardware driving module, and converting the apparatus data into data in a standard format;

dividing, after parsing the apparatus data that is converted into the standard format, the apparatus data into touch event data and control protocol data;

encapsulating, according to a preset first data encapsulation format, the touch event data into a touch event;

dispatching, according to an event dispatching mechanism of an operating system, the touch event to corresponding application software;

parsing the control protocol data, and sending the parsed control protocol data to corresponding application software.

As an improvement of the above scheme, dispatching the touch event to the corresponding application software according to the event dispatching mechanism of the operating system comprises:

dispatching, according to the event dispatching mechanism of the operating system, the touch event to application software at the uppermost layer of the system.

As an improvement of the above scheme, the method further comprises:

sending the touch event to whiteboard application software when it is determined that an inquiry data packet sent by the whiteboard application software is received;

the whiteboard application software responding after receiving the touch event, and no longer responding to the touch event received according to the event dispatching mechanism of the system.

As an improvement of the above scheme, dividing the apparatus data into the touch event data and the control protocol data comprises:

acquiring a data packet header format of the apparatus data;

dividing, according to the data packet header format, the apparatus data into the touch event data and the control protocol data.

As an improvement of the above scheme, the data processing method further comprises:

acquiring application data sent by the application software;

performing, according to the preset first data encapsulation format, format encapsulation on the application data;

sending the encapsulated application data to the hardware driving module.

An embodiment of the present application further provides a data processing method, comprising:

a hardware abstraction layer acquiring apparatus data sent by a hardware driving module, and converting the apparatus data into data in a standard format;

the hardware abstraction layer dividing, after parsing the apparatus data that is converted into the standard format, the apparatus data into touch event data and control protocol data;

the hardware abstraction layer sending the touch event data to an application framework layer;

the application framework layer encapsulating, according to a preset first data encapsulation format, the touch event data into a touch event;

the application framework layer sending the touch event to a touch event dispatching module;

the touch event dispatching module dispatching, according to an event dispatching mechanism of an operating system, the touch event to corresponding application software;

the hardware abstraction layer sending the control protocol data to a protocol control module;

the protocol control module parsing the control protocol data, and sending the parsed control protocol data to corresponding application software.

As an improvement of the above scheme, the touch event dispatching module dispatching the touch event to the corresponding application software according to the event dispatching mechanism of the operating system comprises:

the touch event dispatching module dispatching, according to the event dispatching mechanism of the operating system, the touch event to application software at the uppermost layer of the system.

As an improvement of the above scheme, the method further comprises:

the application framework layer sending the touch event to whiteboard application software when it is determined that an inquiry data packet sent by the whiteboard application software is received;

the whiteboard application software responding after receiving the touch event, and no longer responding to the touch event dispatched by the touch event dispatching module.

As an improvement of the above scheme, the hardware driving module is a driving module of a touch device, the apparatus data is touch data of the touch device, the hardware abstraction layer acquiring apparatus data sent by the hardware driving module and converting the apparatus data into data in the standard format comprises:

the hardware abstraction layer acquiring the touch data sent by the driving module of the touch device, and converting, after calculating and obtaining touch coordinates according to the touch data, the touch coordinates into data in the standard format.

As an improvement of the above scheme, dividing the apparatus data into the touch event data and the control protocol data comprises:

acquiring a data packet header format of the apparatus data;

dividing, according to the data packet header format, the apparatus data into the touch event data and the control protocol data.

As an improvement of the above scheme, the data processing method further comprises:

acquiring application data sent by the application software;

performing, according to the preset first data encapsulation format, format encapsulation on the application data;

sending the encapsulated application data to the hardware driving module.

An embodiment of the present application further provides a data processing device comprising a hardware driving module, a hardware apparatus and a data processing system, wherein the hardware apparatus is connected with the data processing system through the hardware driving module, the data processing system comprises a hardware abstraction layer, an application framework layer, a touch event dispatching module and a protocol control module, the hardware driving module is configured to report apparatus data of the hardware apparatus, the hardware abstraction layer is connected with the application framework layer and the protocol control module respectively, and the application framework layer is connected with the touch event dispatching module;

the hardware abstraction layer is configured to:

acquire apparatus data sent by the hardware driving module, and convert the apparatus data into data in a standard format;

divide, after parsing the apparatus data that is converted into the standard format, the apparatus data into touch event data and control protocol data; and

send the touch event data to the application framework layer;

the application framework layer is configured to: encapsulate, according to a preset first data encapsulation format, the touch event data into a touch event; and

send the touch event to the touch event dispatching module;

the touch event dispatching module is configured to dispatch, according to an event dispatching mechanism of an operating system, the touch event to corresponding application software;

the hardware abstraction layer is further configured to send the control protocol data to the protocol control module;

the protocol control module is configured to parse the control protocol data, and send the parsed control protocol data to application software.

As an improvement of the above scheme, the application framework layer is further configured to:

send the touch event to whiteboard application software when it is determined that an inquiry data packet sent by the whiteboard application software is received; cause the whiteboard application software to respond after receiving the touch event, and no longer to respond to the touch event dispatched by the touch event dispatching module.

An embodiment of the present application further provides a data processing device comprising a touch driving module, a touch device and a data processing system, wherein the touch device is connected with the data processing system through the touch driving module, the data processing system comprises a hardware abstraction layer, an application framework layer, a touch event dispatching module and a protocol control module, the touch driving module is configured to report touch data of the touch device, the hardware abstraction layer is connected with the application framework layer and the protocol control module respectively, and the application framework layer is connected with the touch event dispatching module;

the hardware abstraction layer is configured to:

acquire touch data sent by the touch driving module, and converting, after calculating and obtaining touch coordinates according to the touch data, the touch coordinates into data in the standard format;

divide, after parsing the touch data that is converted into the standard format, the touch data into touch event data and control protocol data; and

send the touch event data to the application framework layer; the application framework layer is configured to: encapsulate, according to a preset first data encapsulation format, the touch event data into a touch event;

send the touch event to the touch event dispatching module; and

send the touch event to whiteboard application software when it is determined that an inquiry data packet sent by the whiteboard application software is received;

the touch event dispatching module is configured to dispatch, according to an event dispatching mechanism of an operating system, the touch event to corresponding application software;

the hardware abstraction layer is further configured to send the control protocol data to the protocol control module;

the protocol control module is configured to parse the control protocol data, and send the parsed control protocol data to application software.

Compared with the prior art, a data processing method, device and system is disclosed in the present invention, in which a hardware abstraction layer acquires apparatus data sent by a hardware driving module and converts the apparatus data into data in a standard format, and after parsing the apparatus data that is converted into the standard format, divides the apparatus data into touch event data and control protocol data, divides the apparatus data into touch event data and control protocol data, divides the apparatus data into touch event data and control protocol data; the application framework layer encapsulates, according to a preset first data encapsulation format, the touch event data into a touch event, and sends the touch event to a touch event dispatching module; the touch event dispatching module dispatches, according to an event dispatching mechanism of an operating system, the touch event to corresponding application software; and a protocol control module parses the control protocol data and sends the parsed control protocol data to corresponding application software. Therefore, the present invention can achieve effective communication between the application software and a hardware apparatus, and in the process of the application software acquiring the apparatus data input by the hardware apparatus, effectively improve the efficiency of data processing and ensure the timeliness of data transmission. And because the present invention supports the bidirectional interaction of data between the application software and the hardware apparatus, the application software no longer passively receives the data input by the hardware apparatus in one direction, and can realize the control function of the hardware apparatus.

### BRIEF DESCRIPTION OF THE DRAWINGS

The present invention will be further described below with reference to the accompanying drawings and embodiments;

FIG. 1 is a schematic diagram of a system input structure of an operating system in the prior art;

FIG. 2 is a schematic diagram of steps of a data processing method according to Embodiment 1 of the present invention;

FIG. 3 is a schematic diagram of steps of a data processing method according to Embodiment 2 of the present invention;

FIG. 4 is a schematic diagram of structures of a data processing device according to Embodiment 3 of the present invention.

### DESCRIPTION OF THE PREFERRED EMBODIMENT

Embodiments of the present invention are described in detail below, examples of which are shown in the accompanying drawings, wherein the same or similar reference numerals denote the same or similar elements or elements having the same or similar functions throughout. The embodiments described below with reference to the accompanying drawings are exemplary and serve only to explain the present invention, and should not be construed as limiting the present invention.

In the description of the present invention, it is to be understood that the azimuth description, such as the azimuth or position relationship indicated by up, down, front, rear, left, right, etc., is based on the azimuth or position relationship shown in the drawings, and is only for the purpose of facilitating the description of the present invention and simplifying the description, rather than indicating or implying that the device or element referred to must have a particular azimuth or be constructed and operated in a particular azimuth, and therefore cannot be understood as a limitation on the present invention.

In the description of the present invention, the meaning of “several” is one or more, the meaning of “a plurality of” is two or more, “greater than”, “less than”, “more than” and the like are to be understood as not including the present number, and “above”, “below”, “within” and the like are to be understood as including the present number. The description of “first” and “second” is only for the purpose of distinguishing technical features, rather than being understood as indicating or implying the relative importance or implicitly specifying the number of indicated technical features or implicitly specifying a precedence relationship of the indicated technical features.

Furthermore, the terms “first” and “second” are only used for descriptive purposes, and should not be understood as indicating or implying relative importance or implicitly specifying the number of indicated technical features. Thus, features defined by “first” and “second” may explicitly or implicitly include one or more features.

In the description of the present invention, it is to be noted that, unless otherwise expressly specified and limited, the term “connection” should be understood in a broad sense. For example, it may be a fixed connection or a movable connection, a detachable connection or a non-detachable connection, or an integral connection; it may be a mechanical connection, an electrical connection or a mutual communication; it may be a direct connection or an indirect connection through an intermediate medium; it may be a connection within two elements, an indirect connection, or an interaction between two elements.

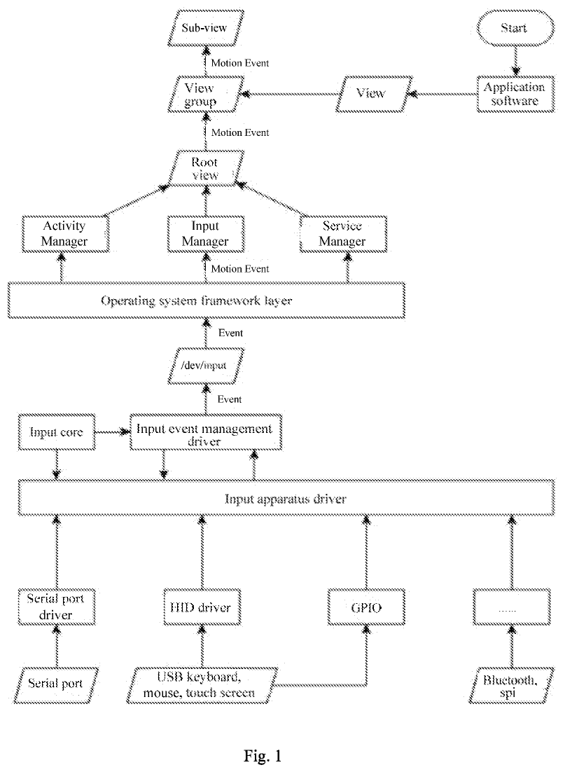

Referring to FIG. 1, a schematic diagram of a system input structure of an operating system in the prior art is shown. It is to be noted that the operating system includes but is not limited to an Android system and a Linux system. In the prior art, a hardware apparatus such as a USB mouse, a keyboard or a touch screen has the support of corresponding drivers, and these drivers generate corresponding apparatus nodes in order to enable the hardware apparatus to interact with application software in the operating system. The third-party application software must acquire, through the system input structure preset by the operating system, the underlying data input by the corresponding hardware apparatus in each hardware driver. However, the data processing flow of the system input structure is time-consuming and complicated, and the application layer can only passively receive data encapsulated according to a certain standard in one direction, but cannot perform a corresponding control function through the input structure.

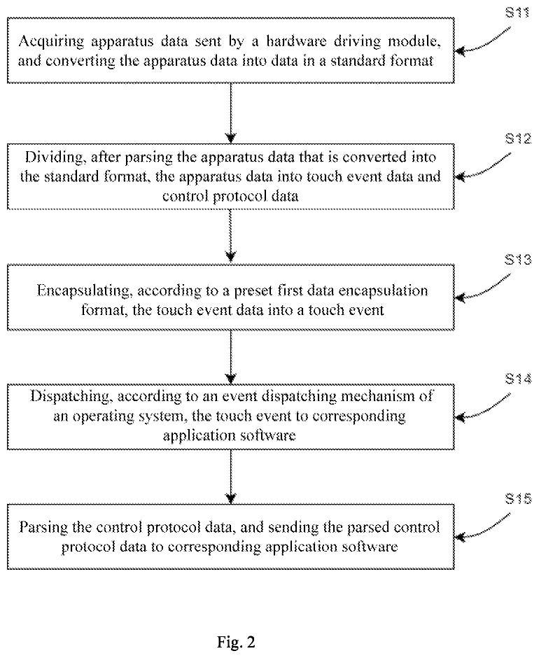

In order to solve the above technical problems, Embodiment 1 of the present invention provides a data processing method. Referring to FIG. 2, a schematic diagram of steps of a data processing method according to Embodiment 1 of the present invention is shown. In the embodiment of the present invention, another data processing structure is provided in the operating system to implement interaction between the hardware apparatus and the application software. For convenience of description, the embodiment of the present invention will be described with a data processing device as an execution body.

The data processing method is specifically executed through steps S11 to S14:

S11: acquiring apparatus data sent by a hardware driving module, and converting the apparatus data into data in a standard format. This step is executed by a hardware abstraction layer of the system, wherein the hardware abstraction layer first converts the apparatus data into the data in the standard format, and then performs subsequent processing. By converting the apparatus data of the hardware apparatus sent by different hardware driving modules into the data in the standard format, the data formats of different hardware apparatus can be unified, so that the upper application software can respond uniformly without interpreting the privatization protocol for each hardware apparatus. The hardware abstraction layer can implement the permission restriction of the Android system, and meet the isolation requirements of the application software in the Android system and hardware apparatus.

S12: dividing, after parsing the apparatus data that is converted into the standard format, the apparatus data into touch event data and control protocol data. This step is executed by the hardware abstraction layer of the system, wherein the data is parsed and dispatched based on the hardware abstraction layer, so that the data can be processed quickly and the resource consumption of the system can be reduced.

S13: encapsulating, according to a preset first data encapsulation format, the touch event data into a touch event;

S14: dispatching, according to an event dispatching mechanism of an operating system, the touch event to corresponding application software;

S15: parsing the control protocol data, and sending the parsed control protocol data to corresponding application software. In this step, the application software to which the control protocol data is dispatched may be the same application software as the application software to which the touch event is dispatched in step S14, or may be different application software.

In the embodiment of the present invention, the data processing device is connected with the hardware apparatus through the hardware driving module, so as to directly acquire apparatus data input by peripheral hardware apparatus through the hardware driving module. Then, the hardware driving module converts the apparatus data into data in a standard format, parses the apparatus data that is converted into the standard format, divides the apparatus data into touch event data and control protocol data, and performs different data processing. Wherein the touch event data comprises data such as a trigger event input by hardware apparatus such as a mouse, a keyboard, a touch screen, a serial port, or a Bluetooth apparatus, and the control protocol data comprises data such as a control instruction input by hardware apparatus such as a mouse, a keyboard, a touch screen, a serial port, or a Bluetooth apparatus.

Preferably, step S12 is specifically executed through steps 121 to 122:

S121: acquiring a data packet header format of the apparatus data;

S122: dividing, according to the data packet header format, the apparatus data into the touch event data and the control protocol data.

After dividing the apparatus data into the touch event data and the control protocol data, in order to ensure the uniformity of the touch event data and reduce the parsing work of the upper application software, in the embodiment of the present invention, with reference to the encapsulation format of the touch event data in the original system input structure in the operating system, format encapsulation is performed on the touch event data to obtain Motion Event data, so that the upper application software can use the Motion Event data provided by the original system data structure, and can also use the Motion Event data provided by the embodiment of the present invention. Further, the embodiment of the present invention can perform packet encapsulation and packet dispatching on the control protocol data in the apparatus data, and transmit it to the application software.

In the embodiment of this application, in step S14, dispatching, according to the event dispatching mechanism of the operating system, the touch event to corresponding application software comprises:

dispatching, according to the event dispatching mechanism of the operating system, the touch event to application software at the uppermost layer of the system.

More specifically, in the dispatching process, the touch event dispatching module dispatches, according to the event dispatching mechanism of the operating system, the touch event to UI focuses of the application software at the uppermost layer of the system, and each UI focus judges whether to consume the touch event. Specifically, the touch event dispatching module dispatches, according to the event dispatching mechanism of the operating system, the touch event to the UI focuses of the application software at the uppermost layer of the system through dispatchTouchEvent. The application software may have a lot of UI focuses, such as controls, elements, etc. A dispatching process of the touch event dispatching module generally starts from the dispatchTouchEvent of the Activity, executes superdispatchTouchEvent(ev), and dispatches the event down. When a certain UI focus responds to the touch event, and onTouchEvent returns true, it means that the touch event has been consumed by the UI focus, so that the touch event dispatching module no longer needs to dispatch it down.

As an improvement of the above scheme, the method further comprises:

S16: sending the touch event to whiteboard application software when it is determined that an inquiry data packet sent by the whiteboard application software is received. The inquiry data packet is used to request the application framework layer to directly send the touch event to the whiteboard application software without dispatching it through the event dispatching mechanism of the system.

S17: the whiteboard application software responding after receiving the touch event, and no longer responding to the touch event received according to the event dispatching mechanism of the system.

A whiteboard application is an application for a user to perform operations such as writing and displaying, and may be used to generate handwriting according to a writing operation of the user on an interface of the whiteboard application, or may be used to insert and display multimedia elements on the interface of the whiteboard application, wherein the multimedia elements may include graphics, images, tables, documents, audio files, and/or video files. In the interface of the whiteboard application, the user may implement operations such as writing, drawing and erasing similar to those on an entity blackboard, and further have better digital functions such as moving, saving, zooming, picture inserting, color adjustment, stroke thickness setting and so on. In an actual application, the whiteboard application may also be named a writing application, an electronic whiteboard application, a cooperative whiteboard application, or the like. No matter how the name is changed, as long as the application is used for implementing the above functions, it is equivalent to the whiteboard application of the present application.

The whiteboard application software can directly read and respond to the touch event, so that the whiteboard application software can send an inquiry data packet and request to directly send the touch event. Thus, the method may not need to dispatch the touch event through the event dispatching mechanism of the system, and directly send the touch event to the whiteboard application software, so that the whiteboard application software responds after receiving the touch event, and no longer responds to the touch event received according to the event dispatching mechanism of the system. This may save time consumed by dispatching the touch event according to the event distribution mechanism of the system, so that the whiteboard application software can respond to the touch event more quickly and improve the efficiency of data response.

In step S15, the protocol control module parses the control protocol data, and sends the parsed control protocol data to the corresponding application software. Specifically, the protocol control module establishes communication with the application software, acquires the control protocol data required by the application software, and thus sends, after parsing the control protocol data, the parsed control protocol data to the corresponding application software. The control protocol data required by different application software may be different. For example, the control protocol data obtained by parsing is a shortcut key operation ctrl+A, and the application software A communicates with the protocol control module in advance to indicate that it requires the data, and then the shortcut key operation ctrl+A is sent to the application software A.

Compared with the system input structure in the prior art, the embodiment of the present invention can provide the transmission function of control instructions between the hardware apparatus and the application software, and improve the flexibility of data processing in the operating system.

As a preferred embodiment, Embodiment 2 of the present invention is further implemented on the basis of Embodiment 1, and the data processing method further includes steps S181 to S183:

S181: acquiring application data sent by the application software;

S182: performing, according to a preset second data encapsulation protocol, format encapsulation on the application data;

S183: sending the encapsulated application data to the hardware driving module.

In the embodiment of the present invention, the method may further acquire the application data sent by the application software, perform protocol encapsulation on the application data according to a preset data protocol between the hardware apparatus and the application software, and dispatch the application data down to the hardware apparatus. The application data includes result data generated after the application software performs an operation such as calculation processing based on the apparatus data acquired from the hardware apparatus, or control instructions for the hardware apparatus generated by the application software.

By adopting the embodiment of the present invention, the data transmission from the application software to the hardware apparatus can be realized by the data processing device, and the bidirectional interaction between the application software and the hardware apparatus can be realized, so that the control function of the application software to the hardware apparatus can be realized on the basis of no additional control module.

In an optional embodiment, for example, the application software is electronic whiteboard writing software, and the hardware apparatus is a touch screen, so as to implement functions of drawing lines by touching, gesture control and shape recognition. Through the touch screen, the user may touch and slide out a corresponding geometric shape, or perform operations such as gesture movement. The electronic whiteboard writing software can quickly draw a corresponding geometric shape according to the user's touch sliding track on the touch screen, and realize corresponding gesture recognition and control functions according to the position relationship of the touch object on the plane, the area relationship of each finger, and the movement trend of the finger, or calculate the shape of the touch object according to the area of the touch object and the coordinates of the touch point. The realization of these functions requires highly real-time touch data, and requires bidirectional data interaction and data customization.

Based on this, with the data processing method according to the embodiment of the present invention, the whiteboard application software can efficiently acquire the touch event data input by the touch screen, and then directly pass the touch event data to the drawing layer of the application software. In addition, for the complex data required for shape recognition, the whiteboard application software generates a corresponding control instruction, performs protocol encapsulation on the control instruction according to a preset protocol between the whiteboard application software and the touch screen, and dispatches the control instruction down to the touch screen hardware apparatus. Thus, the touch screen returns the corresponding data to the whiteboard application software through the embodiment of the present invention, so as to meet the requirements of bidirectional interaction, data customization and data security required for shape recognition.

The embodiment of the present invention provides a data processing method, comprising: acquiring apparatus data sent by a hardware driving module, and converting the apparatus data into data in a standard format; after parsing the apparatus data that is converted into the standard format, dividing the apparatus data into touch event data and control protocol data, dividing the apparatus data into touch event data and control protocol data; encapsulating, according to a preset first data encapsulation format, the touch event data into a touch event; dispatching, according to an event dispatching mechanism of an operating system, the touch event to corresponding application software; and parsing the control protocol data, and sending the parsed control protocol data to corresponding application software. By adopting the embodiment of the present invention, in the process of the application software acquiring the underlying data input by the hardware apparatus, the efficiency of data processing is effectively improved, and the timeliness of data transmission is ensured. And there is a data transmission link for bidirectional interaction between the application software and the hardware apparatus, so that the application software no longer passively receives the data input by the hardware apparatus in one direction, but can also realize the control function of the hardware apparatus.

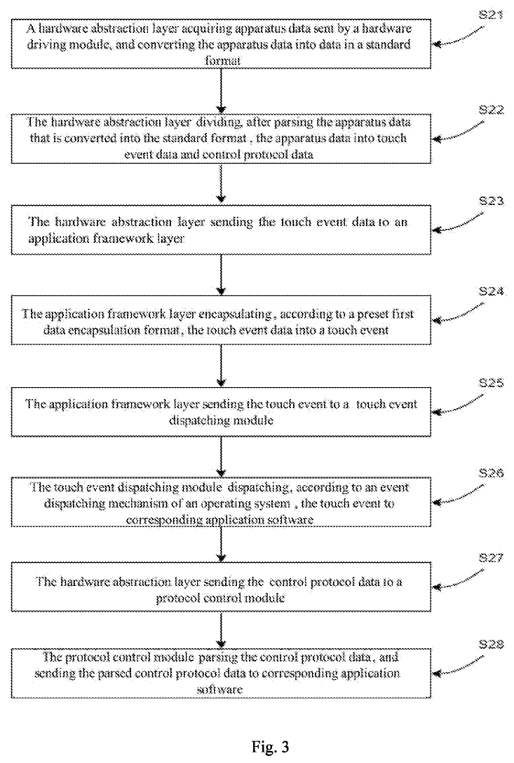

Referring to FIG. 3, a schematic diagram of steps of a data processing method according to Embodiment 2 of the present invention is shown. Embodiment 2 is a further refinement of Embodiment 1, comprising:

S21: a hardware abstraction layer acquiring apparatus data sent by a hardware driving module, and converting the apparatus data into data in a standard format.

The hardware abstraction layer is an interface layer between the kernel of the operating system and the hardware circuit, and its purpose is to abstract the hardware. It hides details of the hardware interface of a specific platform and provides a virtual hardware platform for the operating system, thereby making the operating system hardware-independent and portable on multiple platforms. The hardware abstraction layer first converts the apparatus data into data in the standard format, and then performs subsequent processing. By converting the apparatus data of the hardware apparatus sent by different hardware driving modules into the data in the standard format, the data formats of different hardware apparatus can be unified, so that the upper application software can respond uniformly without interpreting the privatization protocol for each hardware apparatus. The hardware abstraction layer can implement the permission restriction of the Android system, and meet the isolation requirements of the application software in the Android system and hardware apparatus.

S22: the hardware abstraction layer dividing, after parsing the apparatus data that is converted into the standard format, the apparatus data into touch event data and control protocol data. The data is parsed and dispatched based on the hardware abstraction layer, so that the data can be processed quickly and the resource consumption of the system can be reduced.

S23: the hardware abstraction layer sending the touch event data to an application framework layer;

S24: the application framework layer encapsulating, according to a preset first data encapsulation format, the touch event data into a touch event. The application framework layer refers to the Framework layer of Android, through which the touch event can be encapsulated into a touch event that can be recognized by the Android application software;

S25: the application framework layer sending the touch event to a touch event dispatching module;

S26: the touch event dispatching module dispatching, according to an event dispatching mechanism of an operating system, the touch event to corresponding application software;

S27: the hardware abstraction layer sending the control protocol data to a protocol control module;

S28: the protocol control module parsing the control protocol data, and sending the parsed control protocol data to corresponding application software.

As an improvement of the above scheme, in step S26, the touch event dispatching module dispatching, according to the event dispatching mechanism of the operating system, the touch event to the corresponding application software comprises:

the touch event dispatching module dispatching, according to the event dispatching mechanism of the operating system, the touch event to application software at the uppermost layer of the system.

More specifically, in the dispatching process, the touch event dispatching module dispatches, according to the event dispatching mechanism of the operating system, the touch event to UI focuses of the application software at the uppermost layer of the system, and each UI focus judges whether to consume the touch event. Specifically, the touch event dispatching module dispatches, according to the event dispatching mechanism of the operating system, the touch event to the UI focuses of the application software at the uppermost layer of the system through dispatchTouchEvent. The application software may have a lot of UI focuses, such as controls, elements, etc. A dispatching process of the touch event dispatching module generally starts from the dispatchTouchEvent of the Activity, executes superdispatchTouchEvent(ev), and dispatches the event down. When a certain UI focus responds to the touch event, and onTouchEvent returns true, it means that the touch event has been consumed by the UI focus, so that the touch event dispatching module no longer needs to dispatch it down.

As an improvement of the above scheme, the method further comprises:

S29: the application framework layer sending the touch event to whiteboard application software when it is determined that an inquiry data packet sent by the whiteboard application software is received;

S30: the whiteboard application software responding after receiving the touch event, and no longer responding to the touch event dispatched by the touch event dispatching module.

The whiteboard application software can directly read and respond to the touch event, so that the whiteboard application software can send an inquiry data packet and request to directly send the touch event. Thus, the method may not need to dispatch the touch event through the event dispatching mechanism of the system, and directly send the touch event to the whiteboard application software, so that the whiteboard application software responds after receiving the touch event, and no longer responds to the touch event received according to the event dispatching mechanism of the system. This may save time consumed by dispatching the touch event according to the event distribution mechanism of the system, so that the whiteboard application software can respond to the touch event more quickly and improve the efficiency of data response.

As an improvement of the above scheme, the hardware driving module is a driving module of a touch device, the apparatus data is touch data of the touch device, and the hardware abstraction layer acquiring apparatus data sent by the hardware driving module and converting the apparatus data into data in the standard format comprises:

the hardware abstraction layer acquiring the touch data sent by the driving module of the touch device, and converting, after calculating and obtaining touch coordinates according to the touch data, the touch coordinates into data in the standard format. After collecting original touch data, conventional touch apparatus calculates the touch coordinates, and then sends them to the hardware abstraction layer through the hardware driving module. When the calculation amount of the touch data is large, the touch apparatus may need to consume more apparatus resources to calculate the touch coordinates, thus affecting the response speed of the touch apparatus. In this embodiment, sending the touch data to the hardware abstraction layer for the calculation of the touch coordinates can reduce the consumption of the apparatus resources of the touch apparatus, thus improving the response speed of the touch apparatus. For the operating system, the hardware abstraction layer has strong computing power, and the calculation of the touch coordinates through the hardware abstraction layer can quickly obtain the calculation results, resulting in a faster response and more efficient data processing compared with the scheme of calculating the touch coordinates by the hardware apparatus.

As an improvement of the above scheme, dividing the apparatus data into the touch event data and the control protocol data comprises:

acquiring a data packet header format of the apparatus data;

dividing, according to the data packet header format, the apparatus data into the touch event data and the control protocol data.

As an improvement of the above scheme, the data processing method further comprises:

acquiring application data sent by the application software;

performing, according to the preset first data encapsulation format, format encapsulation on the application data;

sending the encapsulated application data to the hardware driving module.

In this embodiment, a hardware abstraction layer acquires apparatus data sent by a hardware driving module and converts the apparatus data into data in a standard format, after parsing the apparatus data that is converted into the standard format, divides the apparatus data into touch event data and control protocol data, divides the apparatus data into touch event data and control protocol data; the application framework layer encapsulates, according to a preset first data encapsulation format, the touch event data into a touch event, and sends the touch event to a touch event dispatching module; the touch event dispatching module dispatches, according to an event dispatching mechanism of an operating system, the touch event to corresponding application software; and a protocol control module parses the control protocol data and sends the parsed control protocol data to the corresponding application software. Therefore, this embodiment can achieve effective communication between the application software and a hardware apparatus, and in the process of the application software acquiring the apparatus data input by the hardware apparatus, effectively improve the efficiency of data processing and ensure the timeliness of data transmission. And because the present invention supports the bidirectional interaction of data between the application software and the hardware apparatus, the application software no longer passively receives the data input by the hardware apparatus in one direction, and can realize the control function of the hardware apparatus.

It is to be noted that this embodiment is a further refinement of Embodiment 1 and has the same working principles and beneficial effects as the flow steps of Embodiment 1, and therefore the same details will not be repeated.

Embodiment 3 of the present application provides a data processing system, comprising:

a data acquiring module for acquiring apparatus data sent by a hardware driving module and converting the apparatus data into data in a standard format;

a data dispatching module for dividing, after parsing the apparatus data that is converted into the standard format, the apparatus data into touch event data and control protocol data;

an event encapsulation module for encapsulating, according to a preset first data encapsulation format, the touch event data into a touch event;

an event dispatching module for dispatching, according to an event dispatching mechanism of an operating system, the touch event to corresponding application software;

a protocol processing module for parsing the control protocol data and sending the parsed control protocol data to corresponding application software.

In the embodiment of the present invention, the data acquiring module is connected with a hardware driving module of each hardware apparatus, and the data dispatching module is bidirectionally connected with the data acquiring module. The data dispatching module is bidirectionally connected with the protocol processing module, and the protocol processing module is bidirectionally connected with the application software; the output of the data dispatching module is connected with the input of the event encapsulation module; the output of the event encapsulation module is connected with the input of the application software.

The data acquiring module is configured to implement communication with the hardware driving module, so as to directly acquire the apparatus data input by peripheral hardware apparatus through the hardware driving module.

The data dispatching module divides the apparatus data into the touch event data and the control protocol data, and performs different data processing. Wherein the touch event data comprises data such as a trigger event input by hardware apparatus such as a mouse, a keyboard, a touch screen, a serial port, or a Bluetooth apparatus, and the control protocol data comprises data such as a control instruction input by hardware apparatus such as a mouse, a keyboard, a touch screen, a serial port, or a Bluetooth apparatus.

As a preferred embodiment, the data dispatching module is specifically configured to:

acquire a data packet header format of the apparatus data; divide, according to the data packet header format, the apparatus data into the touch event data and the control protocol data; send the touch event data to the event encapsulation module, and send the control protocol data to the protocol processing module.

Further, after the data dispatching module divides the apparatus data into the touch event data and the control protocol data, in order to ensure the uniformity of the touch event data and reduce the parsing work of the upper application software, in the embodiment of the present invention, with reference to the encapsulation format of the touch event data in the original system input structure in the operating system, the event encapsulation module performs format encapsulation on the touch event data to obtain Motion Event data, so that the upper application software can use both the Motion Event data provided by the original system data structure and the Motion Event data provided by the embodiment of the present invention. The protocol processing module is configured to perform packet encapsulation and packet dispatching on the control protocol data, and transmit it to the application software. Compared with the system input structure in the prior art, the embodiment of the present invention can provide the transmission function of control instructions between the hardware apparatus and the application software, and improve the flexibility of data processing in the operating system.

As a preferred embodiment, the data dispatching module is further configured to buffer the apparatus data when it is determined that the event encapsulation module or the protocol processing module does not meet a preset data processing condition.

Specifically, after acquiring the apparatus data, the upper application may not consume the data immediately due to refresh rate of the system interface and processing power. To ensure that the acquired apparatus data will not be lost before being recognized by the upper application, in the embodiment of the present invention, after receiving the apparatus data sent by the data acquiring module, the data dispatching module buffers the apparatus data if it determines that the current processing power of the event encapsulation module or the protocol processing module does not meet the preset condition, until the current processing power of the event encapsulation module or the protocol processing module meets the preset condition, and then dispatches the divided touch event data and control protocol data.

Preferably, in the data dispatching module, a ring buffer queue is mainly used to buffer data while converting the buffered data into pointers to reduce memory consumption.

As a preferred embodiment, the protocol processing module is further configured to:

acquire application data sent by the application software;

perform, according to a preset second data encapsulation protocol, format encapsulation on the application data;

send encapsulated application data to the data dispatching module, so that the data dispatching module sends the encapsulated application data to a hardware interaction module, and then the hardware interaction module sends the encapsulated application data to the hardware driving module.

In the embodiment of the present invention, the protocol processing module can further acquire the application data sent by the application software, encapsulate the application data according to a preset data protocol between the hardware apparatus and the application software, and dispatch the application data down to the hardware apparatus. The application data includes result data generated after the application software performs an operation such as calculation processing based on the apparatus data acquired from the hardware apparatus, or control instructions for the hardware apparatus generated by the application software.

By adopting the embodiment of the present invention, the data transmission from the application software to the hardware apparatus can be realized by the data processing device, and the bidirectional interaction between the application software and the hardware apparatus can be realized, so that the control function of the application software to the hardware apparatus can be realized on the basis of no additional control module.

As a preferred embodiment, the data dispatching module is further configured to encrypt the parsed control protocol data or the encapsulated application data.

In the embodiment of the present invention, in order to improve the security of data transmission, after parsing the received control protocol data, the data dispatching module further encrypts and then forwards the control protocol data. It can be understood that, after encapsulating the received application data, the data dispatching module further encrypts and then forwards the application data. Meanwhile, the data dispatching module can also realize the decryption of the encrypted data.

The embodiment of the present invention provides a data processing device comprising a hardware interaction module, a data dispatching module, an event encapsulation module and a protocol processing module. The hardware interaction module acquires apparatus data sent by a hardware driving module; the data dispatching module divides the apparatus data into touch event data and control protocol data; the event encapsulation module performs format encapsulation on the touch event data according to a preset first data encapsulation protocol, and sends the encapsulated touch event data to application software; the protocol processing module parses the control protocol data, and sends the parsed control protocol data to the application software. The present invention realizes the interaction between the application software and hardware apparatus through the data processing device, and in the process of the application software acquiring the underlying data input by the hardware apparatus, effectively improves the efficiency of data processing, and ensures the timeliness of data transmission. And since the data processing device supports bidirectional data interaction, the application software no longer passively receives the data input by the hardware apparatus in one direction, but can realize the control function of the hardware apparatus through the data processing device.

The working principle and beneficial effect of the data processing system of this embodiment corresponds to that of the flow steps of the data processing method according to Embodiment 1, and therefore the same details will not be repeated.

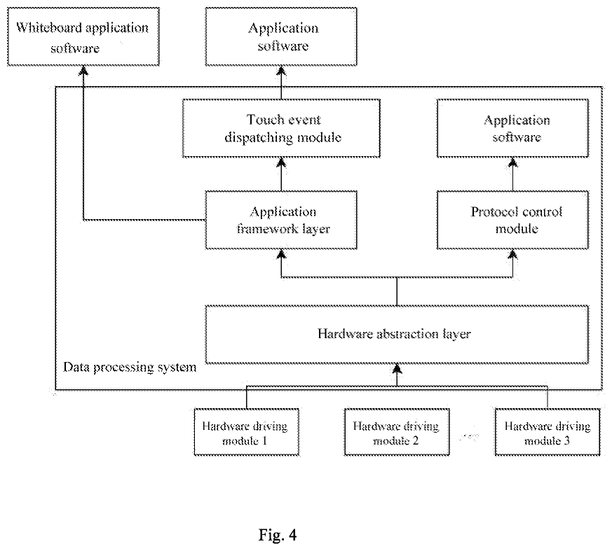

Referring to FIG. 4, the embodiment of the present application further provides a data processing device comprising a hardware driving module, a hardware apparatus and a data processing system, wherein the hardware apparatus is connected with the data processing system through the hardware driving module, the data processing system comprises a hardware abstraction layer, an application framework layer, a touch event dispatching module and a protocol control module, the hardware driving module is configured to report apparatus data of the hardware apparatus, the hardware abstraction layer is connected with the application framework layer and the protocol control module respectively, and the application framework layer is connected with the touch event dispatching module;

the hardware abstraction layer is configured to:

acquire apparatus data sent by the hardware driving module, and convert the apparatus data into data in a standard format;

divide, after parsing the apparatus data that is converted into the standard format, the apparatus data into touch event data and control protocol data; and

send the touch event data to the application framework layer;

the application framework layer is configured to: encapsulate, according to a preset first data encapsulation format, the touch event data into a touch event; and

send the touch event to the touch event dispatching module;

the touch event dispatching module is configured to dispatch, according to an event dispatching mechanism of an operating system, the touch event to corresponding application software;

the hardware abstraction layer is further configured to send the control protocol data to the protocol control module;

the protocol control module is configured to parse the control protocol data, and send the parsed control protocol data to the application software.

As an improvement of the above scheme, the application framework layer is further configured to:

send the touch event to whiteboard application software when it is determined that an inquiry data packet sent by the whiteboard application software is received; cause the whiteboard application software to respond after receiving the touch event, and no longer to respond to the touch event dispatched by the touch event dispatching module.

The data processing device according to this embodiment is of the same concept as that of the data processing method embodiment according to Embodiment 2, and its specific implementation process is detailed in the method embodiment, and will not be repeated here.

In addition, in the embodiment of the present invention, the data processing device further includes an original system input structure, and the connection relationship between the system input structure and the application software can be shown in FIG. 1. The data processing system according to the present invention and the original input structure of the operating system are independent and separate, but coexist in the operating system. As the application software at the uppermost layer of the system, it has no right to modify this part of the function, but it has the right to choose whether or not to use the input events acquired by the system input structure. Therefore, by means of the data processing device according to the embodiment of the present invention, the upper application software can use the data processing system alone to realize data interaction with the hardware apparatus, or use the system input structure at the same time to realize data interaction with the hardware apparatus, and the two parts of the structure do not affect each other. Therefore, the compatibility of the original input structure of the operating system is ensured through minor changes to the data processing structure of the operating system.

The embodiment of the present application further provides a data processing device, comprising a touch driving module, a touch device and a data processing system, wherein the touch device is connected with the data processing system through the touch driving module, the data processing system comprises a hardware abstraction layer, an application framework layer, a touch event dispatching module and a protocol control module, the touch driving module is configured to report touch data of the touch device, the hardware abstraction layer is connected with the application framework layer and the protocol control module respectively, and the application framework layer is connected with the touch event dispatching module;

the hardware abstraction layer is configured to:

acquire the touch data sent by the touch driving module, and converting, after calculating and obtaining touch coordinates according to the touch data, the touch coordinates into data in the standard format;

divide, after parsing the touch data that is converted into the standard format, the touch data into touch event data and control protocol data; and

send the touch event data to the application framework layer;

the application framework layer is configured to: encapsulate, according to a preset first data encapsulation format, the touch event data into a touch event;

send the touch event to the touch event dispatching module; and

send the touch event to whiteboard application software when it is determined that an inquiry data packet sent by the whiteboard application software is received;

the touch event dispatching module is configured to dispatch, according to an event dispatching mechanism of an operating system, the touch event to corresponding application software;

the hardware abstraction layer is further configured to send the control protocol data to the protocol control module;

the protocol control module is configured to parse the control protocol data, and send the parsed control protocol data to the application software.

The data processing device according to this embodiment is of the same concept as that of the data processing method embodiment according to Embodiment 2, and its specific implementation process is detailed in the method embodiment, and will not be repeated here.

Similarly in addition, in the embodiment of the present invention, the data processing device further includes an original system input structure, and the connection relationship between the system input structure and the application software can be shown in FIG. 1. The data processing system according to the present invention and the original input structure of the operating system are independent and separate, but coexist in the operating system. As the application software at the uppermost layer of the system, it has no right to modify this part of the function, but it has the right to choose whether or not to use the input events acquired by the system input structure. Therefore, by means of the data processing device according to the embodiment of the present invention, the upper application software can use the data processing system alone to realize data interaction with the hardware apparatus, or use the system input structure at the same time to realize data interaction with the hardware apparatus, and the two parts of the structure do not affect each other. Therefore the compatibility of the original input structure of the operating system is ensured through minor changes to the data processing structure of the operating system.

Although embodiments of the present invention have been shown and described, it will be understood by those of ordinary skill in the art that various changes, modifications, substitutions and variations may be made to these embodiments without departing from the principles and purposes of the present invention, and the scope of which is defined by the claims and their equivalents.

What is claimed is:

1. A data processing method, comprising:
acquiring apparatus data sent by a hardware driving module, and converting the apparatus data into data in a standard format;
dividing, after parsing the apparatus data that is converted into the standard format, the apparatus data into touch event data and control protocol data;
encapsulating, according to a preset first data encapsulation format, the touch event data into a touch event;
dispatching, according to an event dispatching mechanism of an operating system, the touch event to corresponding application software;
parsing the control protocol data, and sending the parsed control protocol data to corresponding application software.

2. The data processing method according to claim 1, wherein dispatching the touch event to the corresponding application software according to the event dispatching mechanism of the operating system comprises:
dispatching, according to the event dispatching mechanism of the operating system, the touch event to application software at the uppermost layer of the system.

3. The data processing method according to claim 1, wherein the method further comprises:
sending the touch event to whiteboard application software when it is determined that an inquiry data packet sent by the whiteboard application software is received;
the whiteboard application software responding after receiving the touch event, and no longer responding to the touch event received according to the event dispatching mechanism of the system.

4. The data processing method according to claim 1, wherein dividing the apparatus data into the touch event data and the control protocol data comprises:
acquiring a data packet header format of the apparatus data;
dividing, according to the data packet header format, the apparatus data into the touch event data and the control protocol data.

5. The data processing method according to claim 1, wherein the data processing method further comprises:
acquiring application data sent by application software;
performing, according to a preset second data encapsulation format, format encapsulation on the application data;
sending the encapsulated application data to the hardware driving module.

6. A data processing method, comprising:
a hardware abstraction layer acquiring apparatus data sent by a hardware driving module, and converting the apparatus data into data in a standard format;
the hardware abstraction layer dividing, after parsing the apparatus data that is converted into the standard format, the apparatus data into touch event data and control protocol data;
the hardware abstraction layer sending the touch event data to an application framework layer;
the application framework layer encapsulating, according to a preset first data encapsulation format, the touch event data into a touch event;
the application framework layer sending the touch event to a touch event dispatching module;
the touch event dispatching module dispatching, according to an event dispatching mechanism of an operating system, the touch event to corresponding application software;
the hardware abstraction layer sending the control protocol data to a protocol control module;
the protocol control module parsing the control protocol data, and sending the parsed control protocol data to corresponding application software.

7. The data processing method according to claim 6, wherein the touch event dispatching module dispatching the touch event to the corresponding application software according to the event dispatching mechanism of the operating system comprises:
the touch event dispatching module dispatching, according to the event dispatching mechanism of the operating system, the touch event to application software at the uppermost layer of the system.

8. The data processing method according to claim 6, wherein the method further comprises:
the application framework layer sending the touch event to whiteboard application software when it is determined that an inquiry data packet sent by the whiteboard application software is received;
the whiteboard application software responding after receiving the touch event, and no longer responding to the touch event dispatched by the touch event dispatching module.

9. The data processing method according to claim 6, wherein the hardware driving module is a driving module of a touch device, the apparatus data is touch data of the touch device, the hardware abstraction layer acquiring apparatus data sent by the hardware driving module and converting the apparatus data into data in the standard format comprises:
the hardware abstraction layer acquiring the touch data sent by the driving module of the touch device, and converting, after calculating and obtaining touch coordinates according to the touch data, the touch coordinates into data in the standard format.

10. The data processing method according to claim 6, wherein dividing the apparatus data into the touch event data and the control protocol data comprises:
acquiring a data packet header format of the apparatus data;
dividing, according to the data packet header format, the apparatus data into the touch event data and the control protocol data.

11. The data processing method according to claim 6, wherein the data processing method further comprises:
acquiring application data sent by application software;
performing, according to a preset second data encapsulation format, format encapsulation on the application data;
sending the encapsulated application data to the hardware driving module.

12. A data processing device, comprising a hardware driving module, a hardware apparatus and a data processing system, wherein the hardware apparatus is connected with the data processing system through the hardware driving module, the data processing system comprises a hardware abstraction layer, an application framework layer, a touch event dispatching module and a protocol control module, the hardware driving module is configured to report apparatus data of the hardware apparatus, the hardware abstraction layer is connected with the application framework layer and the protocol control module respectively, and the application framework layer is connected with the touch event dispatching module;
the hardware abstraction layer is configured to:
acquire apparatus data sent by the hardware driving module, and convert the apparatus data into data in a standard format;
divide, after parsing the apparatus data that is converted into the standard format, the apparatus data into touch event data and control protocol data; and
send the touch event data to the application framework layer;
the application framework layer is configured to:
encapsulate, according to a preset first data encapsulation format, the touch event data into a touch event; and
send the touch event to the touch event dispatching module;
the touch event dispatching module is configured to dispatch, according to an event dispatching mechanism of an operating system, the touch event to corresponding application software;
the hardware abstraction layer is further configured to send the control protocol data to the protocol control module;
the protocol control module is configured to parse the control protocol data, and send the parsed control protocol data to application software.

13. The data processing device according to claim 12, wherein the application framework layer is further configured to:
send the touch event to whiteboard application software when it is determined that an inquiry data packet sent by the whiteboard application software is received; cause the whiteboard application software to respond after receiving the touch event, and no longer to respond to the touch event dispatched by the touch event dispatching module.

14. A data processing device, comprising a touch driving module, a touch device and a data processing system, wherein the touch device is connected with the data processing system through the touch driving module, the data processing system comprises a hardware abstraction layer, an application framework layer, a touch event dispatching module and a protocol control module, the touch driving module is configured to report touch data of the touch device, the hardware abstraction layer is connected with the application framework layer and the protocol control module respectively, and the application framework layer is connected with the touch event dispatching module;
the hardware abstraction layer is configured to:
acquire touch data sent by the touch driving module, and converting, after calculating and obtaining touch coordinates according to the touch data, the touch coordinates into data in the standard format;
divide, after parsing the touch data that is converted into the standard format, the touch data into touch event data and control protocol data; and
send the touch event data to the application framework layer;
the application framework layer is configured to:
encapsulate, according to a preset first data encapsulation format, the touch event data into a touch event;
send the touch event to the touch event dispatching module; and
send the touch event to whiteboard application software when it is determined that an inquiry data packet sent by the whiteboard application software is received;
the touch event dispatching module is configured to dispatch, according to an event dispatching mechanism of an operating system, the touch event to corresponding application software;
the hardware abstraction layer is further configured to send the control protocol data to the protocol control module;
the protocol control module is configured to parse the control protocol data, and send the parsed control protocol data to application software.
